(19) United States
(12) Patent Application Publication
(10) Pub. No.: US 2025/0046307 A1
(43) Pub. Date: Feb. 6, 2025

(54) METHOD FOR OPERATING A SPEECH DIALOGUE SYSTEM AND SPEECH DIALOGUE SYSTEM

(71) Applicant: MERCEDES-BENZ GROUP AG, Stuttgart (DE)

(72) Inventor: Jasper PANKNIN, Calw (DE)

(21) Appl. No.: 18/716,677

(22) PCT Filed: Nov. 18, 2022
(86) PCT No.: PCT/EP2022/082381

§ 371 Date: Jun. 5, 2024

(30) Foreign Application Priority Data
Dec. 7, 2021 (DE) 10 2021 006 023.7

(51) Int. Cl. G10L 15/22

(52) U.S. Cl. CPC G10L 15/22

(57) ABSTRACT

A method for operating a speech dialogue system in which speech commands of a speech input are recorded and are provided with a level of priority for further processing. Each recognized speech command of several successive speech commands is allocated to a content-related group of commands. Speech commands are linked to a first priority value predetermined for the respective group, after which a second priority value is allocated to each of the speech commands within the group, corresponding to a predetermined priority list of the commands allocated to the group. A third priority value is then formed from the first priority value and the second priority value, and after which the speech commands are sorted into an order corresponding to their final priority value and supplied for processing in this order.

### BACKGROUND AND SUMMARY OF THE INVENTION

Exemplary embodiments of the invention relate to a method for operating a speech dialogue system, in which speech commands of a speech input are recorded and provided with a level of priority for further processing, as well as to a speech dialogue system set up to carry out such a method.

Speech dialogue systems or speech assistants in vehicles are known from the prior art. It is always problematic when the same or phonetically similar commands can be used for controlling different systems. A speech dialogue system for operating vehicle functions, for example, is known from US 2008/0059195 A1. Here, the vehicle functions are respectively allocated to a group of commands. At the same time, levels of priority are allocated to the commands and to the respective vehicle functions. Based on these levels of priority, the further processing is then carried out in order to thus avoid conflicts relating to functions that can be activated using the same or similar commands.

Along with such an adjustment of phonetically similar speech commands for different functions, in practice it is, however, also often the case that speech inputs contain several individual speech commands. These are then often not, not completely, or evenly incorrectly recognized. Then, an incorrect command or only a part of the command or commands, in particular a recognized speech command, is often processed and subsequently carried out. If, in general, several speech commands in the speech input are correctly recognized, then these are typically processed in the uttered or spoken order, which is often not useful. Since the person speaking typically does not give any thought to a serial processing of their speech commands, such a sequence also often does not correspond to their actual desire.

In contrast, exemplary embodiments of the invention are directed to a method enabling a useful sequence for implementation with several commands spoken one after the other.

The method according to the invention, which can preferably be used in a vehicle, provides that, with several successive speech commands in a single speech input, a content-related group of commands is allocated to each of the recognized speech commands. These content-related groups can be, for example, the control of vehicle functions as one of the groups or the control of a navigation system as another group. Further groups could be, for example, the control of a media system, the control of the interior lighting, the operation of a telephony system or similar. The speech command itself is then linked to a first priority value predetermined for the respective group. This priority value can, in principle, be fixedly predetermined or it can also be flexibly adjusted, for example programmed by the vehicle manufacturer or even individually set by the user by means of user pre-sets. Here, automatic learning of the user preferences over time is also conceivable.

After the corresponding speech command has been connected to a group and linked to the corresponding priority value, the speech command itself is now provided with a second priority value within the group corresponding to a predetermined priority list of the commands allocated to the group. The individual commands within the group are thus, in turn, prioritized in terms of their order via a priority list. This priority list can also be correspondingly flexibly adjusted, for example in turn programmed, learned, or even set by the user.

In a following step, a third priority value is then formed from the first and the second priority value, for example by these two values being added up. The crucial aspect of the method is then ultimately that the speech commands are sorted into an order independent of their spoken order corresponding to their final priority values, so here the third priority value, which is preferably the sum of the first two priority values, and supplied in this order for processing.

With this kind of doubled prioritization of the values firstly corresponding to the group to which the speech command is allocated and then within the group corresponding to a priority list, a corresponding prioritization for setting a sensible order of the several successively spoken speech commands of a speech input can already be achieved very well.

A further highly favorable design of the method according to the invention can here provide that the second priority value is smaller than the difference between two adjacent first priority values. In particular in the variant in which the first and the second priority value are added up, this is a crucial advantage. By designing the first priority value in jumps of 10, for example, and designing the second priority value in jumps of one, for example, it is achieved that, when a recognized speech command is prioritized according to its group allocation, it cannot leave the allocated group again due to the second priority value and can thus change the prioritization by means of the group. Due to this special design of the size of the two priority values in relation to each other, the prioritization by means of the group thus always takes precedence over the classification corresponding to the priority list of the group.

A further advantageous design of the method according to the invention further provides that, with the same final priority values, the sorting into the order is carried out according to the spoken order of the speech commands. Thus, if two speech commands have the same final priority value, the system cannot independently set a sensible order of the commands by means of the prioritization. In this case, the order which the speech commands had within the speech input is captured; the speech command uttered first is thus sorted with the same final priority before the speech command uttered after it and correspondingly processed.

A further exceptionally favorable design of the method according to the invention now further evaluates the speech input in terms of temporal adverbs relating to the speech commands. Such temporal adjectives could comprise “before” or “after”, for example, and in practice are used in such a way that it is uttered in the speech input, for example, that a first command is to be carried out before a further command, that this is to be carried out afterwards or that an action initiated by the command is to be carried out first or last. In the case of such recorded temporal adverbs, the method according to the invention provides that a correction value is generated for each of the recognized directions, i.e., whether the command is to be carried correspondingly before or after, the correction value being changed with each further temporal adverb in the same direction in the same sense. Here, in the same sense means that, in the event of a further “before”, an enhancement, i.e., an increase, of the priority value leads to a further increase of the priority value because of a previous “before”, and vice versa. Here, it does not matter, in principle, how the sorting of the order corresponding to the priority values is carried out, i.e., whether first the highest or first the lowest value in the order is sorted, only that the change selected here must of course match this basic principle of the change of the priority value.

The respective third priority value of each speech command is then offset against the correction value thus generated via the temporal adverbs, if these are present. Here too, a simple adding up of the correction value and the third priority value, which for its part preferably consists of the sum of the first and the second priority value, can preferably take place again.

Here, a particularly favorable design of this variant of the method according to the invention moreover provides that the correction value comprises a positive or negative correction factor depending on the direction of the temporal adverb. This would allow the sign of the correction value to be used to represent the recognized direction, in particular, during further simple calculation, for example by forming a sum. Depending on whether the highest or the lowest priority value is sorted at position 1, with the preferred treatment, the lower the priority value is, for example, the “before” direction would have to be correspondingly provided with a factor of −1 and the “after” direction with the factor of +1 in order to obtain the desired additional prioritization using the temporal adverbs.

In addition, a counter can then be increased in each direction with each further temporal adverb, in order to thus correspondingly adjust the priority value by multiplying the counter by the initially set correction value. Here, the amount of the correction factor can preferably be predetermined to be greater than the greatest first priority value of the group with the highest priority value, in order to thus give precedence to the prioritization via the temporal adverbs over the prioritization by the groups upon recognizing temporal adverbs. Here, this helps to avoid overlaps and to achieve an equalization of the sorted speech commands within the order.

Furthermore, according to a very favorable design of the method according to the invention, it can alternatively or additionally also be provided that the speech input is evaluated in relation to concrete specifications for the order of the speech commands, for example when a speech input comprises a first speech command and then, in conjunction with this, an “and after” or “but first”, for example, with a further speech command. An order recognized in this way, which obviously corresponds to the will of the person producing the speech input, is then used with precedence over the final priority values, i.e., the third priority value or the third priority value offset with the correction value.

Here, the concrete specifications about the order can lead to potential gaps in the order of the speech commands, for example when a “thirdly” is spoken during the speech input, although there was only one previous command or similar. However, such gaps in the order of the prioritized and/or classified speech commands are unwanted, since they lead to unnecessary delays in the process. The method can therefore provide for such gaps to be correspondingly filled and, in the event of a gap arising in the order, the speech commands following on in the order to each be shifted forward by one position, in order to thus correspondingly close the gap.

Furthermore, according to an advantageous design, it is the case that the speech commands are checked for similarity, wherein, in the case of speech commands exceeding a predetermined degree of similarity, speech commands from the same group of speech commands are combined. Thus, speech commands, such as “activate the seat heating in the driver's seat”, “activate the seat heating in the passenger seat”, for example, can be combined to form a single command, in which the command “activate the seat heating in the front” is implemented. In doing so, time is correspondingly saved by the serial processing of the commands, and speech commands occurring later on in the order are implemented earlier. Here, checking for potential similarities can be carried out via a semantic check. Alternatively to this or, in particular, in addition to this, combinations of speech commands can also be provided by means of tables, logic functions and/or similar.

Here, in particular, the individual speech commands can be checked for similarity in pairs, since combining very similar commands spoken directly one after the other, in particular, enables a particular degree of efficiency, while commands spoken further apart often no longer indicate such a possibility or necessity.

Furthermore, according to an exceptionally favorable development of the method according to the invention, the speech commands can be checked for defined rules, in order to eliminate any logically nonsensical speech commands or to replace them with further speech commands from the same group of speech commands. If, for example, two temporally successive speech commands refer to playing media content, then a rule can be defined, for example, that only the temporally later speech command is implemented, and the previously spoken speech command is ignored, in order to avoid quickly switching between different playlists or stations in the media device, for example.

A further highly advantageous design of the method according to the invention can now additionally provide that, when processing the speech commands according to their sorted order, emerging error messages for several speech commands of the same group are each only emitted once. If, for example, an error message is generated for a specific group of functions, then this can only be emitted once, in order to not be repeated again with each command allocated to the similar group. If, for example, the speech command “switch on the massage for the driver and switch on the massage in the back left” is emitted, then, in a conventional system, the two recognized commands would lead to two of the same error message, for example “the vehicle does not have massage seats”. In this case, the error message can be combined, such that it is only emitted once and thus the feeling of a comparatively “natural” conversation emerges for a person using the speech dialogue system, in which the same content is not emitted identically multiple times in a row.

The speech dialogue system according to the invention is now constructed to be very similar to a conventional speech dialogue system and has at least one microphone and a device for speech recognition and for natural speech understanding. The speech dialogue system according to the invention here comprises at least one computer unit, which is set up to carry out a method in the sense described above.

In particular, speech outputs can also be provided in the speech dialogue system, for example a speech output for error messages or other notifications of any kind. For this, according to an exceptionally favorable development of the speech dialogue system, a unit for natural speech generation can be provided.

The speech dialogue system and the allocated method can, in principle, be used everywhere where speech dialogue systems are used. In particular, this can be in the field of vehicles. In particular in vehicles, a speech dialogue system is advantageous here, since it enables a person controlling the vehicle to actuate functions inside the vehicle without the person having to turn away from traffic events, which serves for comfort, on the one hand, and traffic safety, on the other hand.

Further advantageous designs of the method according to the invention and of the speech dialogue system according to the invention here also emerge from the exemplary embodiment, which is described below in more detail with reference to the figures.

### BRIEF DESCRIPTION OF THE DRAWING FIGURES

Here are shown:

FIG. 1 a vehicle with a speech dialogue system according to the invention;

FIG. 2 a schematic process for preparing the order of the speech commands; and

FIG. 3 a schematic depiction of the process while processing the speech commands.

### DETAILED DESCRIPTION

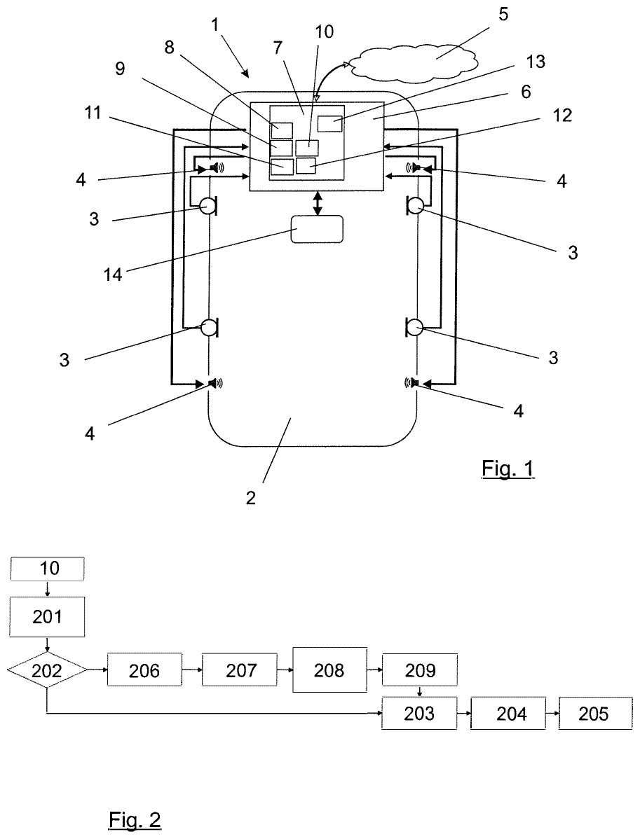

FIG. 1 illustrates a speech dialogue system 1 in a schematically indicated vehicle 2. In the embodiment depicted here, which is generally conventional, the speech dialogue system 1 has four individual microphones 3 for each of the passengers of the vehicle 2 and an output unit allocated to the respective microphone 3 in the form of a loudspeaker 4. Here, the speech dialogue system 1 itself can be formed as a pure speech dialogue system 1 acting in the vehicle 2, which is typically referred to as an embedded system. However, it can also be formed as a pure cloud system and can outsource its arithmetical operations to a server external to the vehicle, which is here indicated as a cloud 5. In particular, the speech dialogue system 1 is to be formed as a hybrid system, i.e., with an embedded portion and a cloud portion.

The speech inputs received by the microphones are communicated to a head unit 6, which comprises the actual speech processing module 7, e.g., as an integrated computer unit. This speech processing module 7 comprises a signal pre-processing device 8, a component 9 for speech recognition, and a component for semantic analysis, which is here labelled with 10 and is often also referred to using the English term of Natural Language Understanding (NLU). The NLU component 10 is here able to process several speech commands spoken one after the other by a person located in the vehicle 2 in a single utterance or speech input and to compartmentalize them into several individual speech commands, so-called intents. In addition, the speech processing module 7 has a text-to-speech component 11 and a component for natural speech output, which is often also referred to as Natural Language Generation or NLG. It is here labelled with 12. Furthermore, a dialogue manager 13 is provided inside the speech processing module 7. The head unit 6 itself is connected to a display 14, which can also optionally be used as part of the speech dialogue for corresponding displays and similar.

Now, if the individual speech commands or intents have been processed in the recognized or spoken order, on the one hand the problem arises that temporal specifications given by the person using the system are not taken into consideration and that the spoken order is not necessarily the actually desired order and, in particular, not the most efficient order, for processing the speech commands.

Thus, the command “call Max Mustermann and start navigation to XY”, for example, would, in sequential processing, lead to the navigation to XY only being started after ending the phone call. Now, with a corresponding prioritization of the recognized speech commands, an optimized order can now also be implemented. Thus, firstly the navigation can be started and only then the phone call is actuated. As a result, the navigation is already available to the person using the vehicle 2 during the phone call, which is mostly an advantage, or is at least never a disadvantage.

Subsequently, a possibility is thus to be described for prioritizing recognized speech commands, for taking into consideration spoken specifications for temporal processing of the speech commands and for substituting two or more successive commands with high degrees of similarity with a single analogous command and, optionally, for anticipating errors during processing.

In order to achieve this, firstly all speech commands or intents recognized in the speech input or speech utterance are now extracted from the delivered data of the NLU component 10, including the information belonging to the respective speech commands. Firstly, an initial priority value is assigned to each of the speech commands, for example a value of 0. In addition, each of the speech commands obtains a value, which corresponds to the spoken position in the speech input or speech utterance.

Subsequently, several possibly optional steps are now described in order to correspondingly influence the priority value and thus the order in which the speech commands are processed.

Initially, it is checked as to whether intents have been identified for which a clear piece of information about the desired order has additionally been spoken. This could be enumerations, such as “firstly”, “secondly”, “start with this”, “lastly” and “finally”, for example. These intents are excluded from the further steps and are then only inserted at the recognized or spoken position of an order of the speech commands before the processing is begun. If here the same position is spoken multiple times, the first temporal specification can be ignored, for example, or the intents with the same temporal specification can be sorted directly one after the other.

For the remaining speech commands or intents, several optional steps follow:

Firstly, a group-specific or domain-specific weighting is carried out, in order to be able to process intents depending on domains belonging to their groups fundamentally before intents from other group domains. Thus, the initially set value of the priority, for example, can be increased depending on the group to which the speech command is allocated by means of a first priority value.

If the speech dialogue system has, for example, the possibility of actuating the groups of telephony, vehicle functions, media, messaging, and navigation, a weighting could, for example, look as is specified below, wherein a lower value here corresponds to a temporally earlier implementation and thus a high degree of priority.
Vehicle functions: 10
Navigation: 20
Media: 30
Messaging: 40
Telephony: 50

Ideally, these values are not rigorously encoded, but rather can be read from a configuration file so that the behavior can be easily optimized or the weighting can be easily deactivated. Corresponding to the belonging group, the initial priority value is increased by the first priority value ascertained in this way. This can preferably be carried out by a simple summation.

In a next step, the speech commands or intents are prioritized within their group. For this, a further second priority value, for example, can be added to the previous first priority value. It can here be advantageous when the third priority values, then newly emerging as a sum of the first and second priority value, are not changed in such a way that the speech commands fall into the value range of a different group. Corresponding to the example described above, the second priority value would thus lie between 1 and 9.

Ideally, these values are also not rigorously encoded, but rather can be read out from a configuration file, in order to be able to easily optimize the behavior. If the inner domain-specific second priority value for each intent is set to 0, no additional weighting is carried out inside the domain.

Additionally, in order to be able to react to temporal adverbs, such as “before” or “after”, in a next optional step, a further correction value is added to the priority values. The intents are here processed according to the spoken sequence. Furthermore, it is checked for each intent as to whether a specification relating to a previous or subsequent processing has been made. If, for example, it is recognized that a “before” has been spoken for an intent, the correction value −100*i*a, for example, is added to this intent and all intents spoken temporally after, wherein i is increased by the value of 1 with each further “before”. In the example, the variable a serves to deactivate the weighting by the value either being set to 1 (on) or 0 (off). If an “after” or similar is correspondingly recognized, an easily modified value +100*j*b is added, wherein b here also analogously serves to deactivate the weighting. The variable j is initially 1 and is increased by the value 1 with each following “after”.

The intents are then sorted according to their final priority values, i.e., the sum of the first and the second priority value and the correction value. If this results in the same final priority values, then the relevant intents are additionally sorted according to their spoken sequence.

In order to shorten dialogues, where possible, the intents are checked for similarity, preferably in pairs, and optionally replaced by a single equivalent intent according to a set of rules.

The intents, for which a concrete temporal specification has been uttered, are then sorted according to the spoken information. Here, if gaps appear, these are eliminated. For example, with an input such as “switch on the heated seats and thirdly put on the light”, the speech commands are sorted into an order according to the described process. However, after sorting the second speech command to third place, a gap emerges in position two, which is eliminated here by bringing forward the intent sorted in third place.

Optionally, a post-processing of the intents is subsequently carried out according to a defined set of rules, in order to avoid meaningless behavior or perceived errors, or in order to combine several intents to form a single analogous intent. For example, if two temporally successive intents relate to playing media content, a rule could be defined that only the temporally later intent is implemented. Upon the speech input “play Michael Jackson on Spotify and play SWR3”, only the speech command e.g., “play SWR3” would then be carried out, for example.

FIG. 2 illustrates this by the NLU component 10 being symbolized again in the upper left box. In the following box labelled with 201, the corresponding data is then extracted in order for it to form the basis of the sequence. If a numbering is already predetermined, the box 202 branches out directly to the box 203, which correspondingly combines with its order and supplies the subsequent post-processing by the set of rules in the box 204, before the final order is fixed in the box 205. If such a numbering is not present, which is typically the case, the prioritization according to the group in which the speech command is classified is undertaken in the region of the box labelled with 206, the first priority value is thus set. In the box labelled with 207, the second priority value is then set, the speech command is thus prioritized again inside its group. The box labelled with 208 then provides the processing of the temporal adverbs and the spoken temporal processes in the sense described above, thus finally generates the correction values, which are correspondingly offset in the box labelled with 209 and supplied to the combination of the speech commands with their priority values or the numbers of their order corresponding to the priority values. The processes of the boxes 204 and 205 then analogously follow on.

In a concrete example it could look as follows. The speech input could be: “Set Sindelfingen as an interim destination, drive to Stuttgart, activate the seat heating for the driver, switch on the seat heating for the passenger as well, set the temperature to 21° beforehand and firstly activate massage!”

```
  Intents in spoken order:
Navi.add.interimdestination <Sindelfingen>; navi.add.destination <Stuttgart>;
function.switchon.seatheating <driver>; function.switchon.seatheating <passenger>;
function.set.temp <21><beforehand>; function.switchon.massage <firstly>
  Intents after checking agreed order:
With specification: function.switchon.massage <firstly>
Without specification: navi.add.interimdestination <Sindelfingen>; navi.add.destination
<Stuttgart>; function.switchon.seatheating <driver>; function.switchon.seatheating
<passenger>; function.set.temp <21><beforehand>
  Intents without expected order according to domain-specific prioritization:
function.switchon.seatheating <driver>; function.switchon.seatheating <passenger>;
function.set.temp <21><beforehand>; navi.add.interimdestination <Sindelfingen>;
navi.add.destination <Stuttgart>;
  Intents without expected order according to inner domain-specific
prioritization:
function.switchon.seatheating <driver>; function.switchon.seatheating <passenger>;
function.set.temp <21><beforehand>; navi.add.destination <Stuttgart>;
navi.add.interimdestination <Sindelfingen>;
  Intents without expected order according to prioritization according to the
occurring temporal adverbs or temporal conjunctions:
function.set.temp <21><beforehand>; function.switchon.seatheating <driver>;
function.switchon.seatheating <passenger>; navi.add.destination <Stuttgart>;
navi.add.interimdestination <Sindelfingen>;
  Intents after amalgamation:
function.switchon.massage <firstly>; function.set.temp <21><beforehand>;
function.switchon.seatheating <driver>; function.switchon.seatheating <passenger>;
navi.add.destination <Stuttgart>; navi.add.interimdestination <Sindelfingen>;
  Intents after rule-based post-processing
function.switchon.massage <firstly>; function.set.temp <21><beforehand>;
function.switchon.seatheating <front>; navi.add.destination <Stuttgart>;
navi.add.interimdestination <Sindelfingen>;
After sorting into this order, the system begins to process the speech commands
individually and one after the other in the ascertained order.
```

If errors emerge when processing individual intents, which would emerge to the same extent for intents from the same group that are to be processed temporally later, the system is able to eliminate these temporally later intents from the processing queue by using a fixed set of rules. For example, it may be the case that the vehicle does not have massage seats, yet the user says “switch on massage for the driver and switch on massage in the back left”. If the two recognized intents were simply processed, then the same error prompt “unfortunately this vehicle does not have massage seats” would be emitted twice. However, as a result of an amalgamation, the error prompt is only emitted once. This suffices to inform the user and conveys a more natural dialogue manner.

If a user speaks further speech commands while previously recognized speech commands are being carried out in the meantime, the system can optionally ignore the newly spoken speech commands or add them to the queue of commands still to be processed.

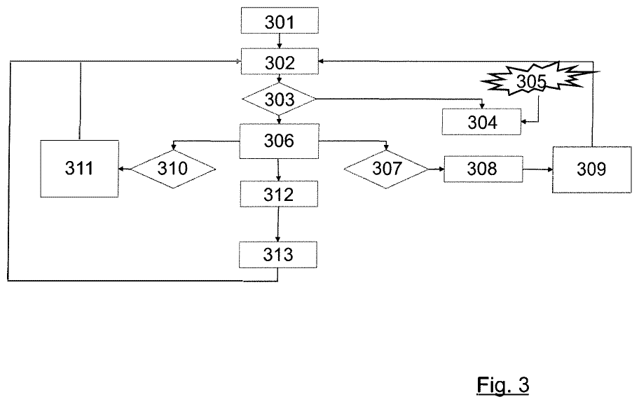

This is addressed in the depiction of FIG. 3. The box 301 starts the processing of the previously rendered, already sorted or prioritized speech commands of an input chain i.e., a command chain with successive speech commands. The box 302 then symbolizes reading the input chain, the query 303 checks whether an input chain is present, if not the determination is ended in box 304 and the process terminated. The speech dialogue is then ended. The same applies when the dialogue, as indicated in box 305, is terminated by the user. If the input chain is not empty, the first speech command in the prioritized input chain is carried out in the box 306. If a check in box 307 reveals an error, the command processed in 306 is removed from the input chain in box 308, and the commands remaining in the input chain are checked by means of a set of rules. If it is to be expected that a command would cause the same or a comparable error, these commands are deleted from the command queue in box 309. An example of the error case is, for example, “switch on the XY massage for the driver and switch on the YZ massage in the back right”. The commands cannot be amalgamated and would thus be carried out sequentially. When carrying out the first command, an error “unfortunately there are no massage seats in this vehicle” now emerges. The command is then deleted from the error queue, since it has already been processed. The remaining commands are then checked and, in this case, the second spoken command is also discarded and the dialogue ended.

The box 312 then describes the normal case, namely that the speech command has been successfully processed without interruption, after which it is deleted from the input chain according to the box 313, after which it jumps back to the box 302 again in order to start the process again from the start and to carry out the next command of the input chain. This process is repeated until all speech commands of the input chain are correspondingly processed, and the process ends in the box 304.

The box 310 deals with the case that a new speech input is received, while the commands of the input chain are commands not yet completely processed. In this case, the processing of the command currently in processing is initially carried out in box 311. After this, this command is removed from the command chain and the newly recognized command is added at the first point of the command chain. The input chain with the added new speech input is then supplied to the box 302 again for processing.

In order to yet further optimize the function, the speech dialogue system 1 optionally has an NLG component 12 for emitting prompts, e.g., error or confirmation notifications, along with a classic text-to-speech component 11, the NLG component making it possible to make the emitted prompts more natural. If a user speaks several speech commands, which can be directly carried out without queries, this leads to the respective confirmation prompt being simply output according to the order without an NLG component 12 or laborious sets of rules. For example, “I am switching the seat heating on. I am switching the reading light on.” At this point, it is possible for the NLG component 12 to link prompts, for example, or to formulate them in a more suitable manner. With the NLG component 12, the feedback could then be, for example, “I am switching the seat heating on and I am switching the reading light on” or even more naturally/better “I am switching the seat heating and the reading light on”.

Additionally, or alternatively to the speech output, error or confirmation notifications displayed on the display 14 are also conceivable.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating a speech dialogue system, the method comprising:
recording speech commands of a speech input; and
providing the recorded speech commands a level of priority for further processing,
wherein each recognized speech command of several successive speech commands is allocated to a content-related group of commands, wherein the recognized speech commands are linked to a first priority value predetermined for the respective group, after which a second priority value is allocated to each of the recognized speech commands within the group, wherein the second priority value corresponds to a predetermined priority list of the commands allocated to the group of commands, after which a third priority value is formed from the first priority value and the second priority value, and after which the recognized speech commands are sorted into an order corresponding to a final priority value and supplied for processing in sorted order.

12. The method of claim 11, wherein the second priority value is smaller than difference between two adjacent first priority values.

13. The method of claim 11, wherein recognized speech commands having a same final priority value are sorted according to a spoken order of the recognized speech commands.

14. The method of claim 11, wherein the speech input is evaluated in terms of temporal adverbs relating to the recognized speech commands, wherein a correction value is generated for each of two recognized directions of the temporal adverbs, wherein the correction value is changed with each further temporal adverb in a same direction, and wherein the respective third priority value of each recognized speech command is offset against the correction value.

15. The method of claim 13, wherein the correction value comprises a positive or negative correction factor depending on the direction of the temporal adverb.

16. The method of claim 11, wherein the speech input is evaluated with reference to concrete specifications relating to an order in which the speech commands are spoken, wherein a recognized order is used with precedence over the final priority values for sorting into the sorted order.

17. The method of claim 11, wherein the recorded speech commands are checked for similarities, wherein recorded speech commands exceeding a predetermined degree of similarity from the same group of speech commands are amalgamated.

18. The method of claim 11, wherein the recorded speech commands are checked for defined rules to logically eliminate non-sensical speech commands or to replace the non-sensical speech commands with further speech commands from the same group of speech commands.

19. The method of claim 11, wherein, when processing the recorded speech commands according to their sorted order, emerging error notifications for several speech commands of the same group are each only emitted once.

20. A speech dialogue system, comprising:
at least one microphone;
a computer configured to
record speech commands of a speech input; and
provide the recorded speech commands a level of priority for further processing,
wherein each recognized speech command of several successive speech commands is allocated to a content-related group of commands, wherein the recognized speech commands are linked to a first priority value predetermined for the respective group, after which a second priority value is allocated to each of the recognized speech commands within the group, wherein the second priority value corresponds to a predetermined priority list of the commands allocated to the group of commands, after which a third priority value is formed from the first priority value and the second priority value, and after which the recognized speech commands are sorted into an order corresponding to a final priority value and supplied for processing in sorted order.
